(19) United States
(12) Patent Application Publication
(10) Pub. No.: US 2006/0248560 A1
(43) Pub. Date: Nov. 2, 2006

(54) Video recording/playback apparatus

(75) Inventors: Isao Wada, Hitachinaka (JP); Atsuhiro Ono, Namegata (JP); Toshiya Takko, Kamakura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/367,857

(22) Filed: Mar. 3, 2006

(30) Foreign Application Priority Data
Apr. 28, 2005 (JP) 2005-130745

(51) Int. Cl. H04N 7/173; H04N 7/16

(52) U.S. Cl. 725/89; 725/142; 725/134

(57) ABSTRACT

Video recording/playback apparatuses has the problem that specified thumbnail images are not displayed while specifying unwanted portions so that contents cannot be checked while specifying those sections. A video recording/playback apparatus of the present invention including a section specifier unit that specifies a desired section of video data recorded on a recording medium and a screen generator that generates information for displaying a reduced scale screen representing the specified section. When plural sections are specified by the section specifier unit, the screen specifier unit generates information for displaying position and length information on plural sections that have been specified or a reduced scale screen for the plural specified sections.

### CLAIM OF PRIORITY

The present application claims priority from Japanese patent application No. JP2005-130745 filed on Apr. 28, 2005, the content of which is hereby incorporated by reference into this application.

### BACKGROUND OF THE INVENTION

(1) Field of the Invention

The present invention relates to a video recording/playback apparatus capable of deleting unnecessary portions of video data recorded on a recording medium, and relates in particular to improvements for more convenient operation when deleting plural unnecessary portions.

(2) Description of the Related Art

An object of the technology of the related art for specifying and deleting unnecessary sections after recording is to “allow easy editing that deletes unnecessary sections of information and leaves only essential sections without requiring a complicated process” and that “pressing a designated button when the desired video to delete is displayed while viewing video played back on a monitor, and pressing the designated button again when the video for deleting has ended in order to specify that section, so that video in the section between the first time the button has been pressed and the second time the button is pressed is deleted so that only the necessary portions of the video remain the next time the video is played back” is the means to achieve this object. An example of this technology is disclosed for example in JP-A No. 2003-319312 (Patent Reference 1).

Another object of the technology of the related art for specifying and deleting unnecessary sections during recording is “a simple operation for specifying and deleting a desired unnecessary section during recording without having to playback the recorded file” and that, “The video is shown simultaneously with the start of recording. The pause button is pressed when unnecessary section starts in order to mark the start point. The recording proceeds further and the pause button is pressed again when the unnecessary section ends, in order to mark the end point. When there are other unnecessary sections, the specifying of the start point and end point is repeated. The specified unnecessary sections are then completely deleted in one batch when the recording ends. A recording file with the unnecessary sections deleted is in this way made when the recording ends.” An example of this technology is disclosed for example in JP-A No. 2004-095089 (Patent Reference 2).

### SUMMARY OF THE INVENTION

Hard disks and optical disks such as DVD (Digital Versatile Discs) are becoming increasingly utilized as recording media in recent years. Moreover, much attention is being focused products using DVD and hard disks in video recording/playback apparatuses with a large storage capacity for recording video. These type of video recording/playback apparatuses are capable of recording programs such as television broadcasts on DVD or hard disks.

These programs contain sections that are not wanted or not needed (hereafter called unwanted sections) by the user such as commercials and opening sections or video sections that repeat after or just prior to a commercial. These unwanted sections are also recorded (dubbed) along with the program during recording. These unwanted sections are therefore specified and deleted.

It is important not to mistakenly specify and delete an essential section of the video when deleting these unwanted sections using the technology of the related art. A single program usually contains plural unwanted sections such as commercials and these sections should preferably be checked before starting to delete the plural unwanted sections. To make operation easier, these plural unwanted sections should preferably be deleted all together.

When deleting plural unwanted sections, a thumbnail (reduced scale image) image display makes it easy to check if there are any mistakenly specified sections among the unwanted sections specified up till now. Displaying to what extent what section of a program will be deleted also makes the deleting easy to check and execute.

However in the technology of the related art disclosed in Patent Reference 1 no consideration is given to displaying a thumbnail image for making a check when attempting to specify and delete plural unwanted sections together. The technology of Patent Reference 1 therefore possesses poor operability since deleting plural unwanted sections requires repeatedly specifying and deleting one unwanted section at a time.

The technology of the related art disclosed in Patent Reference 2 displayed a thumbnail image to allow checking the contents after specifying plural unwanted sections for deletion as a batch. During the specifying, however, there is no thumbnail screen display of specified sections so that this related art possesses the problem that the contents cannot be checked during specifying of unwanted sections. Moreover, this related art also possesses the problem that the contents cannot be checked since there is no visual display showing to what extent what section of a program is deleted.

The present invention has the object of providing a video recording/playback apparatus easy to use and convenient for checking contents since it displays thumbnail images of unwanted sections and displays the start position and the end position of unwanted sections, even at the stage where specifying unwanted sections.

These objects are achieved by the invention as described in the claims.

The present invention is therefore easy to use and convenient for checking contents since it displays thumbnail images of unwanted sections and displays the start position and the end position of unwanted sections, even at the stage where specifying unwanted sections.

### BRIEF DESCRIPTION OF THE DRAWINGS

FIG. 1 is a block diagram showing the internal DVD recorder in the hard disk drive of the present invention;

FIG. 2A is a drawing showing a display of a first scene deletion during use of the section deletion function;

FIG. 2B is a drawing showing a display of a first scene deletion during use of the section deletion function;

FIG. 2C is a drawing showing a display of a first scene deletion during use of the section deletion function;

FIG. 2D is a drawing showing a display of a first scene deletion during use of the section deletion function;

FIG. 3A is a drawing showing a display of a fourth scene deletion during use of the section deletion function;

FIG. 3B is a drawing showing a display of a fourth scene deletion during use of the section deletion function;

FIG. 4A is a drawing showing a display of a ninth scene deletion during use of the section deletion function;

FIG. 4B is a drawing showing a display of a ninth scene deletion during use of the section deletion function;

FIG. 5 is a flowchart of the operation of the video recording/playback apparatus of the present invention;

FIGS. 6A to 6D images of reduction of video data of the video recording/playback apparatus of the present invention;

FIGS. 7A and 7B reduced images of video data of the second embodiment in the video recording/playback apparatus of the present invention;

FIG. 8 is an example of the screen display during a batch deletion check.

### DESCRIPTION OF THE PREFERRED EMBODIMENTS

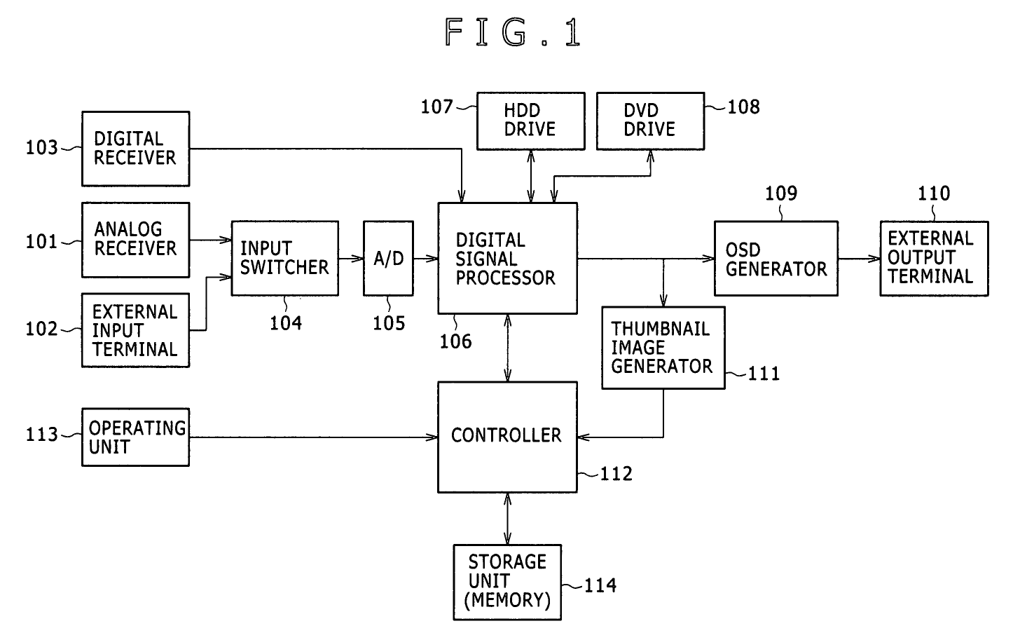

The embodiments of the video recording/playback apparatus of the present invention are described next while referring to FIG. 1 through FIG. 8.

### First Embodiment

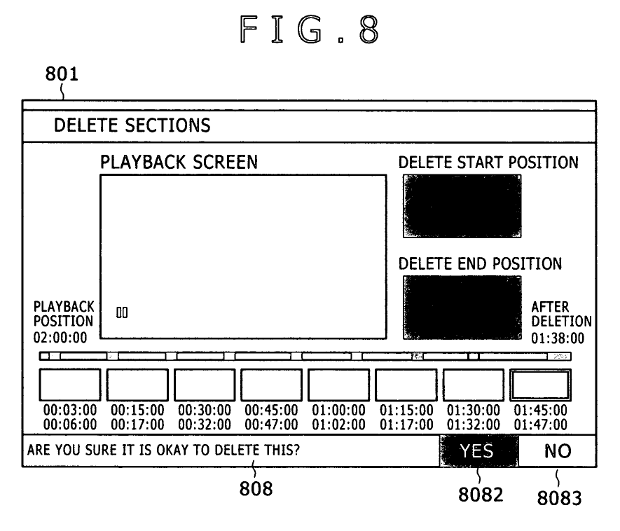

The first embodiment of the video recording/playback apparatus of the present invention is described next while referring to FIG. 1 through FIG. 6 as well as FIG. 8.

FIG. 1 is a block diagram showing the DVD recorder with internal hard disk drive of the first embodiment of the present invention. The internal structure and the operation are described while referring to FIG. 1.

The reference numeral 101 denotes an analog receiver for receiving analog television broadcasts, 102 is an external input terminal for inputting video signals from an external device, 103 is a digital receiver for receiving digital television broadcasts, 104 is an input switcher for switching to the analog receiver 101 and the external input terminal 102, 105 is an A/D (analog/digital) converter for converting the analog video signal to digital video data, 106 is a digital signal processor for compressing or decompressing video data in MPEG format and also performing each type of signal processing, 107 is an HDD drive for recording compressed video data using a hard disk (HDD) as the recording medium, 108 is a DVD drive for recording compressed video data using a DVD as the recording medium, 109 is an OSD generator for generating various information for display such as letters and icons, and overlapping it onto video signals from the digital signal processor 106, 110 is an external output terminal for outputting video signal to the external connected display device, 111 is a thumbnail image generator for generating thumbnail images from video signals played back by the HDD drive 107 or DVD drive 108, 112 is a controller for overall control of this recorder, 113 is an operating unit made up from different buttons utilized by the user when operating this recorder, 114 is a storage unit (memory) for storing thumbnail image data and time information generated in the thumbnail image generator 111.

The operation during recording and playback is first of all described. During recording, the analog receiver 101 receives a television broadcast and outputs a video signal that is selected with the switcher 104, and the A/D 105 next converts the analog video signal to digital video data, which is then input to the digital signal processor 106. The video data input to the digital signal processor 106 is compressed in MPEG format and sent to the HDD drive 107 or the DVD drive and recorded.

The digital signal processor 106 on the other hand outputs a video signal for displaying an image on an external display device. Display information with letters and icons is overlapped onto the video signal by the OSD generator 109 and output from the external output terminal 110 to the external display device.

During playback, the digital signal processor 106 decompresses the compressed video data recorded on the HDD drive 107 or the DVD drive 108 and changes it to video signals overlaid with display information made up of letters and icons by the OSD generator 109 and then output from the external output terminal 110 to the external display device.

The user then sets record mode or playback mode with the operating unit 113 by a specific operation.

The operation in this embodiment for deleting unwanted sections of video is described next. Deleting unwanted sections of a program recorded on the HDD drive 107 is described next.

The user selects a program containing unwanted sections for deletion by using a specified operation in the operating unit 113. When the section-delete function for deleting unwanted sections then starts, the OSD generator 109 generates a display screen for deleting unwanted sections and this is shown on the external display device. The operating unit 113 then sets the recorder to playback, plays the video data from the HDD drive 107, and displays playback images (or playback screen) of unwanted sections decompressed by the digital signal processor 106 on the display screen.

The user searches for the start position of unwanted sections to delete while viewing the playback screen in fast-forward or fast-frame. When the start position appears on the playback screen, the user specifies that start position using the operation in the operating unit 113. The thumbnail image generator 111 makes a thumbnail screen for that start position. Time information for that start position along with the thumbnail image data is stored in the storage unit 114.

The user searches for the end position of the unwanted sections to delete while viewing the playback screen, and specifies the end position using the operation in the operating unit 113 when the end position appears on the playback screen. The thumbnail image generator 111 makes a thumbnail screen for that end position and stores time information on the end position along with that thumbnail image data in the storage unit 114. When there are plural unwanted sections, the user again searches for the start position of the unwanted section on the playback screen and specifies it using the operating unit 113.

At this time, a thumbnail image of the first position of the unwanted section that is first registered as well as time information on the start position and end position are loaded from the storage unit 114 and shown on the display screen by the OSD generator 109. Repeating this operation displays the thumbnails specified as unwanted sections as well as time information on the start positions and end positions.

When delete is executed using the operation in operating unit 113 after specifying all the unwanted sections, the controller 112 deletes the video data sections specified as unwanted sections in the target program on the HDD drive 107 in one action.

Unwanted sections can in this way be specified at the desired position, and by displaying thumbnail images of unwanted sections and time information on the start position and end position even at the stage where still specifying unwanted sections, the contents to delete can be easily checked and the operating convenience improved.

The operability can also be improved since deletion is performed in one batch.

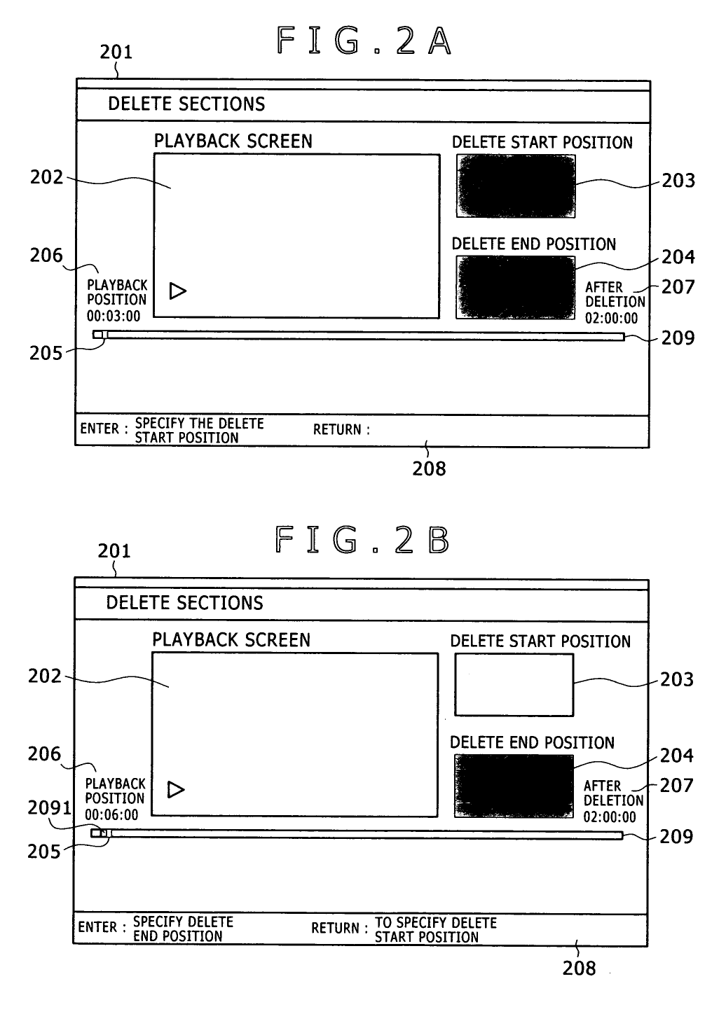

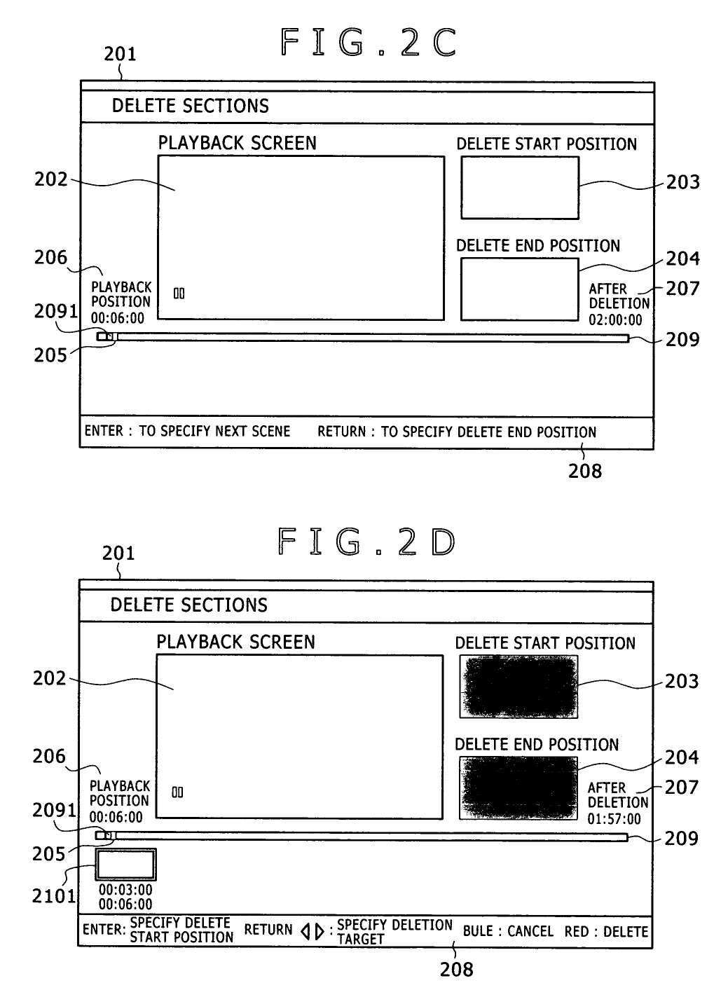

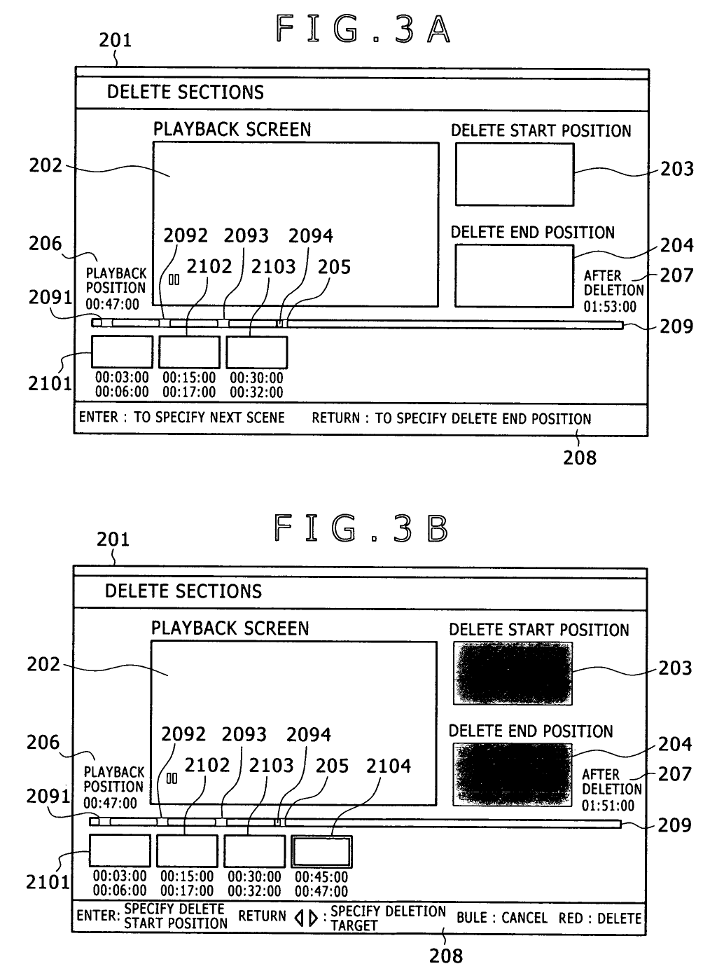

The screen displays that appear in this embodiment during section deletion are described next using FIG. 2 through FIG. 4 as well as FIG. 8. FIG. 2A is an example of a display screen shown after searching for the first delete start position during the section-delete function. FIG. 2B is an example of the display screen shown after specifying the delete start position for the first scene during the section-delete function. FIG. 2C is an example of the display screen shown after specifying the delete end position for the first scene during the section-delete function. FIG. 2D is an example of display screen shown when starting to delete the second scene during the section-delete function. FIG. 3A is an example of the display screen shown after specifying the delete end position of the fourth scene during the section-delete function. FIG. 3B is an example of the display screen shown after starting the search for the delete start position for the fifth scene during the section-delete function. FIG. 4A is an example of the display screen shown after specifying the delete end position for the ninth scene during the section-delete function. FIG. 4B is an example of the display screen shown after starting to search for the delete start position for the tenth scene during the section-delete function. FIG. 8 is an example of the screen shown when checking the batch deletion.

The deletion of sections such as the opening section, commercials, the ending section as unwanted sections in a two-hour program is described next. The scenes for deletion are a total of nine locations and more specifically are 3 to 6 minutes, 15 to 17 minutes, 30 to 32 minutes, 45 to 47 minutes, 1 hour to 1 hour 2 minutes, 1 hour 15 minutes to 1 hour 17 minutes, 1 hour 30 minute to 1 hour 32 minutes, 1 hour 45 minutes to 1 hour 47 minutes, 1 hour 55 minutes to 2 hours. After specifying these scenes for deletion they are deleted in one batch (all together).

When the section-delete function starts and the user presses the playback button of operating unit 113 to set the playback state, a playback screen 202, a playback point 205 for showing an image of the playback position in the program, a playback position time 206 for the program being played, a post-deletion time 207 as the time after subtracting the specified (unwanted section) scene for deletion from the recording time of the program being played, an operation bar 208 for urging the user to perform the next operation, and a program bar 209 for showing an image of the overall program length are displayed as shown on screen 201 in FIG. 2A.

In this example, a location three minutes (00:03:00) from the start of the program is played. The deletion position has not yet been specified so the deletion start position thumbnail image 203 and the deletion end position thumbnail image 204 are not displayed and post-deletion time 207 is two hours (02:00:00). The user searches for the delete start position (three minutes) (00:03:00) of the scene to delete (unwanted section) in fast-forward and fast-frame while viewing the playback screen 202. When the user presses the Enter button while viewing the operation bar 208 and the three minute (00:03:00) position is specified as the delete start position, a thumbnail image is generated and the screen display switches to the display shown in FIG. 2B. The thumbnail image for the delete start position and the time information (three minutes) (00:03:00) are simultaneously registered in the storage unit 114.

A thumbnail image appears in the delete start position thumbnail image 203 as shown in FIG. 2B when the user designates the delete start position. The user here searches for the delete end position (six minutes) (00:06:00) while viewing the playback screen 202. On shifting the playback position, a first scene bar 2091 appears, showing the segment from the delete start position of three minutes (00:03:00) to the playback point 205 (six minutes) (00:06:00) in the currently playing program, on the program bar 209.

When the user checks the operation bar 208 after searching for the delete end position of the scene to delete (unwanted section) and presses the Enter button, the (six minutes) (00:06:00) position is specified as the delete end position, and along with making a thumbnail image at this time, the screen display switches to that shown in FIG. 2C. The thumbnail image for the delete end position and the time information (six minutes) (00:06:00) are also simultaneously registered in the storage unit 114. The segment from three minutes (00:03:00) to (six minutes) (00:06:00) has now been specified as the scene to delete (unwanted section).

When the delete end position is specified, a thumbnail image appears in the delete end position thumbnail image 204 as shown in FIG. 2C. When the user here presses the Enter button to specify the second scene as the next scene to delete (unwanted section), after checking the operation bar 208, the display screen shown in FIG. 2D appears.

Next, the delete start position thumbnail image 203 and the delete end position thumbnail image 204 disappear, when the next screen appears for specifying the second scene as shown in FIG. 2D, and the delete start position thumbnail image for the first scene specified for deletion as well as the delete start position time (00:03:00) as the delete end position time (00:06:00) appear as a first delete icon 2101. The remaining time (01:57:00) when three minutes in the period from 3 minutes to 6 minutes is deleted, also appears in this post-deletion time 207. This screen is a standby state that waits for the user to specify the delete start position for the second scene as the next scene to delete and the process hereafter repeats.

When the user specifies the delete end position for the fourth scene to delete (unwanted section) as shown in FIG. 3A, the thumbnail images for the start position and end positions are respectively displayed on the delete start position thumbnail image 203 and delete end position thumbnail image 204 along with displaying (00:47:00) in the current playback position time 206. The first delete icon 2101, second delete icon 2102, third delete icon 2103, as well as the first scene bar 2091, second scene bar 2092, the third scene bar 2093, the fourth scene bar 2094 are also displayed at the same time. Here the screen displayed in FIG. 3B appears when the user presses the Enter button to further specify the fifth scene to delete next after checking the operation bar 208.

The delete start position thumbnail image 203 and the delete end position thumbnail image 204 then disappear, when the next screen appears for specifying the fifth scene as shown in FIG. 3B, and the delete start position thumbnail image for the fourth scene specified for deletion as well as the delete start position time (00:45:00) and the delete end position time (00:47:00) are additionally displayed as the fourth delete icon 2104. The remaining time (01:51:00) when nine minutes in a total of four deletion scenes is deleted, also appears in this post-deletion time 207. This screen is a standby state that waits for the user to specify the delete start position for the fifth scene as the next scene to delete and the process hereafter repeats.

When the user specifies the delete end position for the ninth scene to delete (unwanted section) as shown in FIG. 4A, the thumbnail images for the start position and end positions are respectively displayed on the delete start position thumbnail image 203 and delete end position thumbnail image 204, along with displaying (02:00:00) in the current playback position time 206, and (01:43:00) in the post-deletion time 207. The first delete icon 2101, the second delete icon 2102, third delete icon 2103, the fourth delete icon 2104, the fifth delete icon 2105, the sixth delete icon 2106, the seventh delete icon 2107, the eighth delete icon 2108, as well as the first scene bar 2091, second scene bar 2092, the third scene bar 2093, the fourth scene bar 2094, the fifth scene bar 2095, the sixth scene bar 2096, the seventh scene bar 2097, the eighth screen bar 2098, and the ninth screen bar 2099 are also displayed at the same time. When the user here presses the Enter button to the tenth scene as the next scene to delete after checking the operation bar 208, the display screen as shown in FIG. 4B then appears.

The delete start position thumbnail image 203 and the delete end position thumbnail image 204 then disappear when the screen for specifying the tenth scene appears as shown in FIG. 4B, and along with displaying (02:00:00) on the current playback position time 206, and (01:38:00) in the post-deletion time 207; the thumbnail image for the delete start position of the ninth scene specified for deletion and the delete start position time (01:55:00) and the delete end position time (02:00:00) are displayed as the ninth delete icon 2109. The display of the first delete icon 2101 through the eighth delete icon 2108 disappear at this time, however these can be displayed by scrolling by pressing the left scroll icon 211. Here, the first delete icon 2101 may be hidden and the second delete icon 2102 through ninth delete icon 2109 may be displayed.

At this point, the user searches for the delete start position if continuing to make deletions, but if the user has finished specifying deletions, then the batch deletion operation begins. Before deleting, the user views thumbnail images of the first delete icon 2101 through ninth delete icon 2109 to confirm whether these can be deleted. If there is no mistake, then the user checks the operation bar 208 and presses the red button serving as the operating unit 113. If, however, a mistake is noticed, then the user can utilize the left/right cursors in the operating unit 113 from among the first delete icon 2101 through ninth delete icon 2109, and press the blue button to remove it from the objects for deletion. When removed as an object for deletion, that deletion icon and its scene bar are no longer displayed, and the post-deletion time 207 is recalculated and displayed. When selecting a delete icon, the thumbnail image inside that selected delete icon may be enclosed in a frame colored yellow for example, and the scene bar also colored yellow in order to make the selection easy to recognize.

The user presses the red button on the screen in FIG. 4B to switch to the batch-delete check screen shown in FIG. 8. A check message, “Are you sure it is okay to delete this?” then appears as shown in the operation bar 808 on screen 801, urging the user to check for operating mistakes. If there are no mistakes, then the user presses “YES” 8082 to start the batch deletion process. If a mistake is noticed, the user presses “NO” 8083 to cancel the deletion process.

In this embodiment, the delete function can be canceled by pressing the Return button when the screens in FIG. 2A, FIG. 2D, FIG. 3B, and FIG. 4B are displayed.

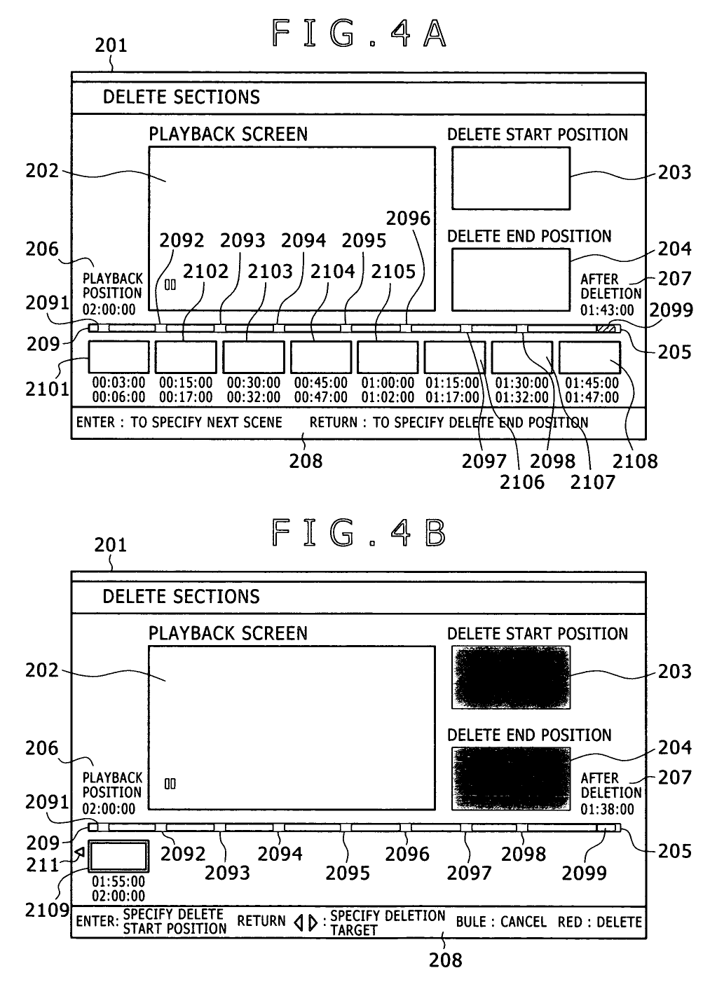

The section deletion process flow in the video recording/playback apparatus of this embodiment is described next while referring to FIG. 5. FIG. 5 is a flowchart showing the operation of the video recording/playback apparatus of this embodiment.

The section delete screen shown in FIG. 2A appears when the user selects the program with the target scene (unwanted section) to delete in step S501 by means of the specified operation from operating unit 113 and the section-delete function starts in step S502. In step S503, the user searches for the delete start position of the scene to delete (unwanted section) shown in FIG. 2A and the process awaits pressing of the Enter button to specify the delete start position. If the Return button is pressed in step S504, then the process returns to step S502 and the section-delete function is canceled. When the user finds the delete start position and presses the Enter button, the process decides the Enter button has been pressed in step S504, generates a thumbnail image for the delete start position in step S505, and stores the thumbnail image data along with time information on the delete start position in the storage unit 114. The process then waits for the user to search for the end position for the scene to delete (unwanted section) and press the Enter button to specify the delete end position.

When the Return button is pressed in step S506, the process returns to step S503 and the user searches for the delete start position. The user then presses the Enter button on finding the delete end position, so when the process decides in step S506 that the Enter button has been pressed, it generates a thumbnail image of the delete end position in step S507, and stores that thumbnail image data along with time information on the delete end position in the storage unit 114.

The first scene to delete can be specified here. The process then awaits pressing of the Enter button to specify any following scenes for deletion. When the user presses the Return button in step S508, the process returns to step S506, and the process then waits for the user to search for the end position for the scene to delete (unwanted section) and press the Enter button to specify the delete end position.

When the user presses the Enter button to delete the next scene, the process decides that the Enter button is pressed in Step S508. In step S509, the thumbnail image for the delete start position, the time information on the delete start position and time information on the delete end position recorded in the storage unit 114, are loaded (read out), and displayed on the screen as the delete icon, and the post-deletion time after a specified scene is deleted is calculated and displayed on the screen. If deleting the second scene as the next section to delete, the user then presses the Enter button after searching for the delete start position. In step S510, the process then decides that the Enter button is pressed, returns to step S505, generates a thumbnail image of the second delete start position, stores time information on the second scene delete start position along with the thumbnail image data into the storage unit 114, and this process then repeats until there are no more scenes specified as delete sections. When there are no more scenes to delete, the user checks the display screens FIG. 4A and FIG. 4B for mistakes among the selected scenes. If there are no mistakes, the user presses the red button for deletion so that batch deletion of the plural scenes specified in step S511 begins, and the video data joined without the specified deleted scenes is obtained.

The video data length is in this way changed from 2 hours to 1 hour 38 minutes in this embodiment and the data volume can be reduced. If there is a mistake in the specified scenes, then the user can select that wrong scene with the cursor buttons so that deletion of the wrongly specified scene can be canceled. Therefore, by selecting a delete icon thumbnail screen in step S512 according to the cursor buttons, a delete icon scene can be removed from those scenes targeted for deletion in the selection when the user has pressed the blue button in step S513, the display ends, and the process awaits batch deletion processing initiated by the red button.

In this embodiment, the delete start position thumbnail image is utilized as the thumbnail image for displaying the delete icon, however a thumbnail image of the delete end position may be utilized. Moreover, thumbnail images for both the delete start position and the delete end position may be alternately displayed.

The thumbnail image for display as the delete icon may be a moving image thumbnail. Utilizing a moving image makes checking the contents of the scene to delete even easier. The moving picture thumbnail data for the moving picture thumbnail is generated as moving picture thumbnail image data for the playback screen by the thumbnail image generator 111 for a fixed period after the Enter button is pressed to specify the delete start position during playback. The moving picture thumbnail data may also be generated in the period that the user is searching for the delete end position, or other methods may be utilized.

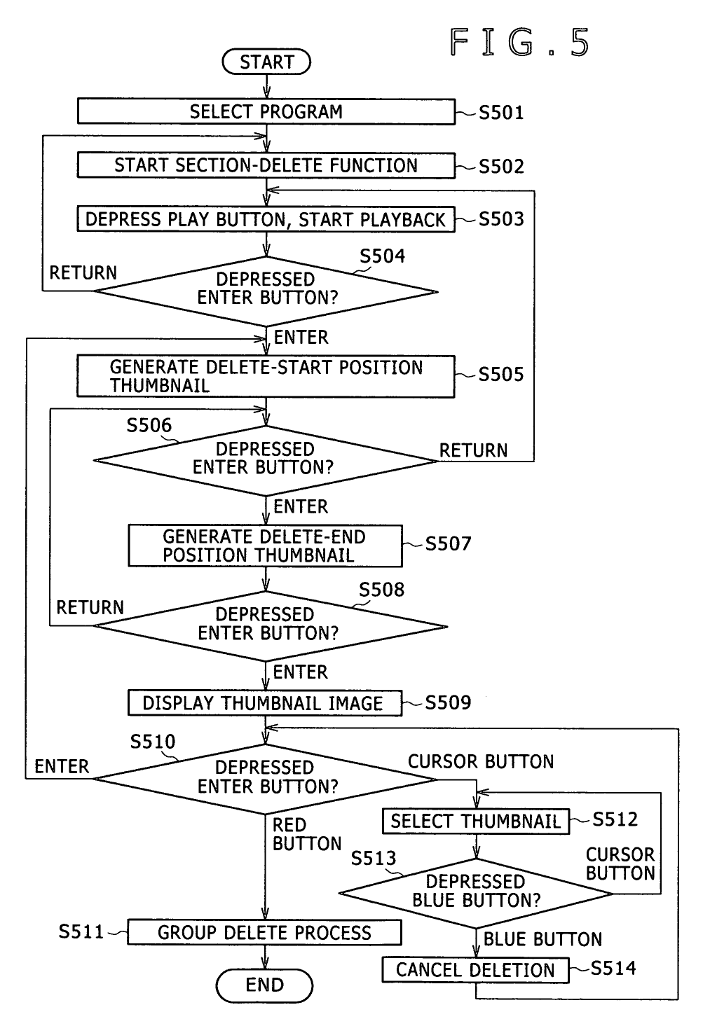

The process for reducing the video data during batch deletion in the video recording/playback apparatus of the present embodiment is described next while referring to FIGS. 6A to 6D. FIGS. 6A to 6D show images of reduction of video data in the video recording/playback apparatus of this embodiment.

As shown in FIG. 6A, the recording time is two hours for the program containing unwanted sections. There are nine locations in this program with delete scenes and these are scenes 2, 4, 6, 8, 10, 12, 14, 16, and 18. Pressing the red button in step S510 starts the batch deletion processing operation. First of all, 1 hour and 54 minutes of video data from scene 3 onwards, is overwritten from the end section of scene 1 (00:03:00) to obtain the video data shown in FIG. 6B. Next, 1 hour and 43 minutes of video data from scene 5 onwards, is overwritten from the end of section 3 (00:12:00) to obtain the video data shown in FIG. 6C.

This process is repeated and video data of 1 hour and 38 minutes with the unwanted sections deleted is obtained as shown in FIG. 6D, and the reduction processing then ends. The data (size) can in this way be reduced during batch deletion processing so that the data capacity of HDD and DVD possessing only a limited data capacity can be effectively used.

### Second Embodiment

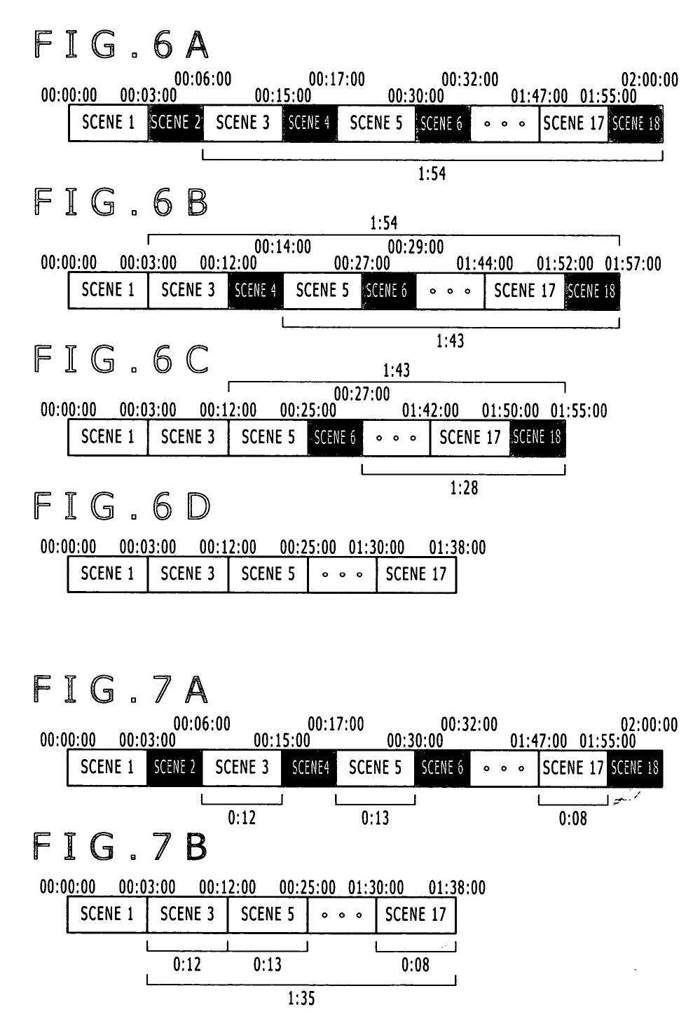

The second embodiment for reducing the video data during batch deletion processing in the video recording/playback apparatus of the present embodiment is described next while referring to FIGS. 7A and 7B. FIGS. 7A and 7B are drawings shows images of reduction of video data in the second embodiment for the video recording/playback apparatus of the present invention.

As shown in FIG. 7A, the recording time is two hours for the program containing unwanted sections. There are nine locations in this program with delete scenes and these are scenes 2, 4, 6, 8, 10, 12, 14, 16, and 18. Pressing the red button in step S510 starts the batch deletion processing operation. The process writes (or overwrites) the scene 3 video data (starting) from the end section of scene 1 (00:03:00). When writing (overwriting) of scene 3 ends, the process then writes (or overwrites) the scene 5 video data (starting) from the end section of scene 3 (00:12:00). This process is repeated and the reduction processing of video data ends at the point that scene 17 is overwritten.

Here, the point differing from the first embodiment, is that the first embodiment overwrites the video containing the scene to delete to the rear of the deletion scene, and therefore there is a large quantity of overwrite data so that sometimes a long time is required for batch processing. In the second embodiment, however, the deletion scene is overwritten in sequence only by video data for the next scene so that the data overwrite size can be kept small and the time needed for batch deletion processing can be shortened. In the example in the first embodiment, video data equivalent to 10 hours 35 minutes is overwritten, however in the second embodiment, only video data equivalent to 1 hour 35 minutes need be overwritten.

The embodiments of the present invention as described above, make checking easy when an unwanted section is specified by displaying a thumbnail image of the unwanted section, and the position and length of the unwanted section, and improve the (apparatus) operating convenience.

In particular, the video recording/playback apparatus of the embodiments of the present invention including section specifier unit for specifying an optional section of video data recorded on a recording medium and screen generator for generating information for displaying a reduced scale screen representing the specified section, is characterized in that the screen generator generates position information on what section of the video data the plural specified sections are in or information for displaying reduced scale images of the specified plural sections when plural sections are specified by the section specifier unit. Displaying a thumbnail image of the unwanted section, and the position and length of the unwanted section makes checking easy when an unwanted section is specified, and improves the (apparatus) operating convenience.

Moreover, the present invention is characterized in that the reduced scale image may be a static image or a moving picture image. Making the reduced scale image (thumbnail image) a moving picture image allows easily checking the contents that are to be deleted.

Further, the present invention includes deletion unit for deleting sections specified by the section specifier unit, and is characterized in that when the deletion unit deletes the plural specified sections after the section specifier unit has specified the sections, the deletion unit deletes the specified sections in one batch. The operating performance is therefore improved since deleting is performed in one batch after specifying the plural unwanted sections.

Still further, the present invention is characterized in that the section specifier unit for specifying a section, specifies a start position and an end position during playback of the video data. Unwanted sections such as commercial sections and opening sections can also be deleted by specifying an optional start position and end position by operating buttons such as an enter button while viewing the playback screen.

What is claimed is:

1. A video recording/playback apparatus comprising:
a section specifier unit that specifies an optional section of video data recorded on a recording medium, and
a screen generator that generates information for displaying a reduced scale screen representing the specified section,
wherein the section specifier unit specifies a start position and an end position during playback of the video data and,
the screen generator generates position information on what section of the video data the plurality of specified sections are in, or information for displaying reduced scale images of the plurality of specified sections, when a plurality of sections are specified by the section specifier unit.

2. The video recording/playback apparatus according to claim 1, wherein the reduced scale image is a static image or a moving image.

3. The video recording/playback apparatus according to claim 1, wherein the reduced scale image is a static image or a moving image of the start position and the end position specified by the section specifier unit during playback of the video data.

4. The video recording/playback apparatus according to claim 1, including a deletion unit that deletes sections specified by the section specifier unit, wherein, when the section specifier unit has specified the plurality of sections, the deletion unit deletes the specified sections in one batch.

5. The video recording/playback apparatus according to claim 1, further including a deletion unit that deletes sections specified by the section specifier unit, and a selection unit that selects some of the plurality of sections after the section specifier unit has specified the sections, wherein, when the deletion unit deletes the specified sections, the deletion unit deletes in one batch the specified sections selected by the selection unit.
